(19) United States
(12) Patent Application Publication
(10) Pub. No.: US 2015/0121682 A1
(43) Pub. Date: May 7, 2015

(54) EXTRACTION TOOL ASSEMBLY

(71) Applicant: United Technologies Corporation, Hartford, CT (US)

(72) Inventors: Chelsea Brown, Newington, CT (US); Glenn E. Malasmas, Manchester, CT (US)

(21) Appl. No.: 14/398,088

(22) PCT Filed: Apr. 25, 2013
(86) PCT No.: PCT/US2013/038105

§ 371 Date: Oct. 30, 2014

Related U.S. Application Data
(60) Provisional application No. 61/640,761, filed on May 1, 2012.

(51) Int. Cl. F01D 25/28; B25B 33/00

(52) U.S. Cl. CPC F01D 25/285; B25B 33/00; F05D 2230/31
USPC 29/527.2; 29/700

(57) ABSTRACT

An exemplary extraction tool assembly includes, among other things, a base having a slot to receive a component held within a fixture. The base is moved to cause the component to move relative to the fixture.

### CROSS-REFERENCE TO RELATED APPLICATIONS

This application claims priority to U.S. Provisional Application No. 61/640,761, which was filed on 1 May 2012 and is incorporated herein by reference.

### BACKGROUND

This disclosure relates generally to a tool and, more particularly, to a masked blade extraction tool assembly.

A gas turbine engine typically includes a fan section, a compressor section, a combustor section, and a turbine section. Air entering the compressor section is compressed and delivered into the combustion section where it is mixed with fuel and ignited to generate a high-speed exhaust gas flow. The high-speed exhaust gas flow expands through the turbine section to drive the compressor section and the fan section. The compressor section typically includes low and high pressure compressors, and the turbine section includes low and high pressure turbines.

The high pressure turbine drives the high pressure compressor through an outer shaft to form a high spool, and the low pressure turbine drives the low pressure compressor through an inner shaft to form a low spool. The fan section may also be driven by the low spool. A direct drive gas turbine engine includes a fan section driven by the low spool such that the low pressure compressor, low pressure turbine, and fan section rotate at a common speed in a common direction.

A speed reduction device such as an epicyclical gear assembly may be utilized to drive the fan section such that the fan section may rotate at a speed different than the turbine section so as to increase the overall propulsive efficiency of the engine. In such engine architectures, a shaft driven by one of the turbine sections provides an input to the epicyclical gear assembly that drives the fan section at a reduced speed such that both the turbine section and the fan section can rotate at closer to optimal speeds.

Individual fan blades are mounted within a hub or rotor driven by the gear assembly. The configuration and geometry of the fan blades balance propulsive efficiency with durability and fatigue requirements.

Although engines with geared architectures have improved propulsive efficiency, turbine engine manufacturers continue to seek further improvements to engine performance including improvements to thermal transfer and propulsive efficiencies.

Components of the turbine engines, such as blades, have surfaces that are treated. Other surfaces of the components may be masked during the treatment. A fixture holds the components during the treatment. Example treatments include coating operations. Removing the masked components from the fixtures after treatments is often difficult.

### SUMMARY

An extraction tool assembly according to an exemplary aspect of the present disclosure includes, among other things, a base having a slot to receive a component held within a fixture. The base is moved to cause the component to move relative to the fixture.

In a further non-limiting embodiment of the foregoing extraction tool assembly, the base is pivoted relative to the fixture to cause the component to move relative to the fixture.

In a further non-limiting embodiment of any of the foregoing extraction tool assemblies, the component is a gas turbine engine component.

In a further non-limiting embodiment of any of the foregoing extraction tool assemblies, the assembly includes a first insert and a second insert, the first insert having a first slot configured to engage a first component and the second insert having a second slot that is configured to engage a second component different than the first component, a size of the first slot different than a size of the second slot.

In a further non-limiting embodiment of any of the foregoing extraction tool assemblies, the first insert and the second insert are selectively engageable with the base.

In a further non-limiting embodiment of any of the foregoing extraction tool assemblies, the first insert and the second insert each include at least one hook to engage an edge portion of the base.

In a further non-limiting embodiment of any of the foregoing extraction tool assemblies, the assembly includes a handle extending from one end of the base.

In a further non-limiting embodiment of any of the foregoing extraction tool assemblies, the assembly includes a pair of arms of the base extending away from a handle end of the base, the slot positioned between the pair of arms.

In a further non-limiting embodiment of any of the foregoing extraction tool assemblies, the assembly includes a tabbed area of the arms to be received within a groove of the fixture.

In a further non-limiting embodiment of any of the foregoing extraction tool assemblies, the fixture is a coating fixture.

An exemplary method of moving a gas turbine engine component relative to a fixture according to another exemplary aspect of the present disclosure includes, among other things, moving an extraction tool relative to a fixture to cause a component held by the fixture to move relative to the fixture.

In a further non-limiting embodiment of the foregoing method of moving a gas turbine engine component relative to a fixture, the method may include placing the component within a slot of the extraction tool and pivoting the extraction tool to move the component.

In a further non-limiting embodiment of any of the foregoing methods of moving a gas turbine engine component relative to a fixture, the insert of the tool provides the slot, and the insert is selected based on the component.

In a further non-limiting embodiment of any of the foregoing methods of moving a gas turbine engine component relative to a fixture, the method includes securing a selected insert to a base portion of the extraction tool to change an effective size of the slot.

In a further non-limiting embodiment of any of the foregoing methods of moving a gas turbine engine component relative to a fixture, the method includes placing the component within the fixture and coating a portion of the component prior to the moving.

In a further non-limiting embodiment of any of the foregoing methods of moving a gas turbine engine component relative to a fixture, the method includes coating a tip of the component and masking a remaining portion of the component during the coating.

In a further non-limiting embodiment of any of the foregoing methods of moving a gas turbine engine component relative to a fixture, the method includes placing a tab of the extraction tool within a groove of the fixture during the moving.

In a further non-limiting embodiment of any of the foregoing methods of moving a gas turbine engine component relative to a fixture, the method includes contacting a masked area of the component during the moving.

### DESCRIPTION OF THE FIGURES

The various features and advantages of the disclosed examples will become apparent to those skilled in the art from the detailed description. The figures that accompany the detailed description can be briefly described as follows:

FIG. 1 illustrates an example gas turbine engine.

FIG. 2 shows a perspective view of an example extraction tool assembly used to move component of the FIG. 1 engine relative to a fixture.

FIG. 3 shows a perspective view of the extraction tool assembly of FIG. 2 without an insert.

FIG. 4 shows another perspective view of the extraction tool assembly of FIG. 2 without an insert.

FIG. 5 shows a top view of selected inserts for use with the extraction tool of FIG. 2.

FIG. 6 shows a perspective view of one of the inserts of FIG. 5.

FIG. 7 shows a perspective view of the other of the inserts of FIG. 5.

FIG. 8 shows an example component extracted by the extraction tool assembly of FIG. 7.

### DETAILED DESCRIPTION

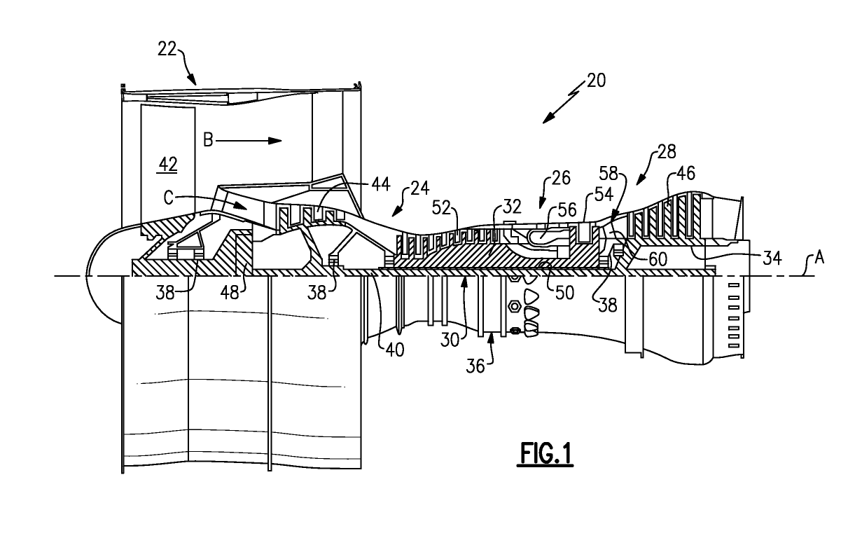

FIG. 1 schematically illustrates an example gas turbine engine 20 that includes a fan section 22, a compressor section 24, a combustor section 26, and a turbine section 28. Alternative engines might include an augmenter section (not shown) among other systems or features. The fan section 22 drives air along a bypass flow path B while the compressor section 24 draws air in along a core flow path C where air is compressed and communicated to a combustor section 26. In the combustor section 26, air is mixed with fuel and ignited to generate a high pressure exhaust gas stream that expands through the turbine section 28 where energy is extracted and utilized to drive the fan section 22 and the compressor section 24.

Although the disclosed non-limiting embodiment depicts a turbofan gas turbine engine, it should be understood that the concepts described herein are not limited to use with turbofans as the teachings may be applied to other types of turbine engines; for example a turbine engine including a three-spool architecture in which three spools concentrically rotate about a common axis and where a low spool enables a low pressure turbine to drive a fan via a gearbox, an intermediate spool that enables an intermediate pressure turbine to drive a first compressor of the compressor section, and a high spool that enables a high pressure turbine to drive a high pressure compressor of the compressor section.

The example engine 20 generally includes a low speed spool 30 and a high speed spool 32 mounted for rotation about an engine central longitudinal axis A relative to an engine static structure 36 via several bearing systems 38. It should be understood that various bearing systems 38 at various locations may alternatively or additionally be provided.

The low speed spool 30 generally includes an inner shaft 40 that connects a fan 42 and a low pressure (or first) compressor section 44 to a low pressure (or first) turbine section 46. The inner shaft 40 drives the fan 42 through a speed change device, such as a geared architecture 48, to drive the fan 42 at a lower speed than the low speed spool 30. The high speed spool 32 includes an outer shaft 50 that interconnects a high pressure (or second) compressor section 52 and a high pressure (or second) turbine section 54. The inner shaft 40 and the outer shaft 50 are concentric and rotate via the bearing systems 38 about the engine central longitudinal axis A.

A combustor 56 is arranged between the high pressure compressor 52 and the high pressure turbine 54. In one example, the high pressure turbine 54 includes at least two stages to provide a double stage high pressure turbine 54. In another example, the high pressure turbine 54 includes only a single stage. As used herein, a “high pressure” compressor or turbine experiences a higher pressure than a corresponding “low pressure” compressor or turbine.\

The example low pressure turbine 46 has a pressure ratio that is greater than about 5. The pressure ratio of the example low pressure turbine 46 is measured prior to an inlet of the low pressure turbine 46 as related to the pressure measured at the outlet of the low pressure turbine 46 prior to an exhaust nozzle.

A mid-turbine frame 58 of the engine static structure 36 is arranged generally between the high pressure turbine 54 and the low pressure turbine 46. The mid-turbine frame 58 further supports bearing systems 38 in the turbine section 28 as well as setting airflow entering the low pressure turbine 46.

The core airflow C is compressed by the low pressure compressor 44 then by the high pressure compressor 52 mixed with fuel and ignited in the combustor 56 to produce high speed exhaust gases that are then expanded through the high pressure turbine 54 and low pressure turbine 46. The mid-turbine frame 58 includes vanes 60, which are in the core airflow path and function as an inlet guide vane for the low pressure turbine 46. Utilizing the vane 60 of the mid-turbine frame 58 as the inlet guide vane for low pressure turbine 46 decreases the length of the low pressure turbine 46 without increasing the axial length of the mid-turbine frame 58. Reducing or eliminating the number of vanes in the low pressure turbine 46 shortens the axial length of the turbine section 28. Thus, the compactness of the gas turbine engine 20 is increased and a higher power density may be achieved.

The disclosed gas turbine engine 20 in one example is a high-bypass geared aircraft engine. In a further example, the gas turbine engine 20 includes a bypass ratio greater than about six (6:1), with an example embodiment being greater than about ten (10:1). The example geared architecture 48 is an epicyclical gear train, such as a planetary gear system, star gear system or other known gear system, with a gear reduction ratio of greater than about 2.3.

In one disclosed embodiment, the gas turbine engine 20 includes a bypass ratio greater than about ten (10:1) and the fan diameter is significantly larger than an outer diameter of the low pressure compressor 44. It should be understood, however, that the above parameters are only exemplary of one embodiment of a gas turbine engine including a geared architecture and that the present disclosure is applicable to other gas turbine engines.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 ft., with the engine at its best fuel consumption—also known as “bucket cruise Thrust Specific Fuel Consumption ('TSFC')”—is the industry standard parameter of pound-mass (lbm) of fuel per hour being burned divided by pound-force (lbf) of thrust the engine produces at that minimum point.

“Low fan pressure ratio” is the pressure ratio across the fan blade alone, without a Fan Exit Guide Vane (“FEGV”) system. The low fan pressure ratio as disclosed herein according to one non-limiting embodiment is less than about 1.50. In another non-limiting embodiment, the low fan pressure ratio is less than about 1.45.

“Low corrected fan tip speed” is the actual fan tip speed in ftsec divided by an industry standard temperature correction of [(Tram ° R) (518.7° R)] ^{0.5}. The “Low corrected fan tip speed,” as disclosed herein according to one non-limiting embodiment, is less than about 1150 ft/second.

The example gas turbine engine includes the fan 42 that comprises in one non-limiting embodiment less than about twenty-six (26) fan blades. In another non-limiting embodiment, the fan section 22 includes less than about twenty (20) fan blades. Moreover, in one disclosed embodiment the low pressure turbine 46 includes no more than about six (6) turbine rotors schematically indicated at 34. In another non-limiting example embodiment, the low pressure turbine 46 includes about three (3) turbine rotors. A ratio between the number of fan blades and the number of low pressure turbine rotors is between about 3.3 and about 8.6. The example low pressure turbine 46 provides the driving power to rotate the fan section 22 and therefore the relationship between the number of turbine rotors 34 in the low pressure turbine 46 and the number of blades in the fan section 22 disclose an example gas turbine engine 20 with increased power transfer efficiency.

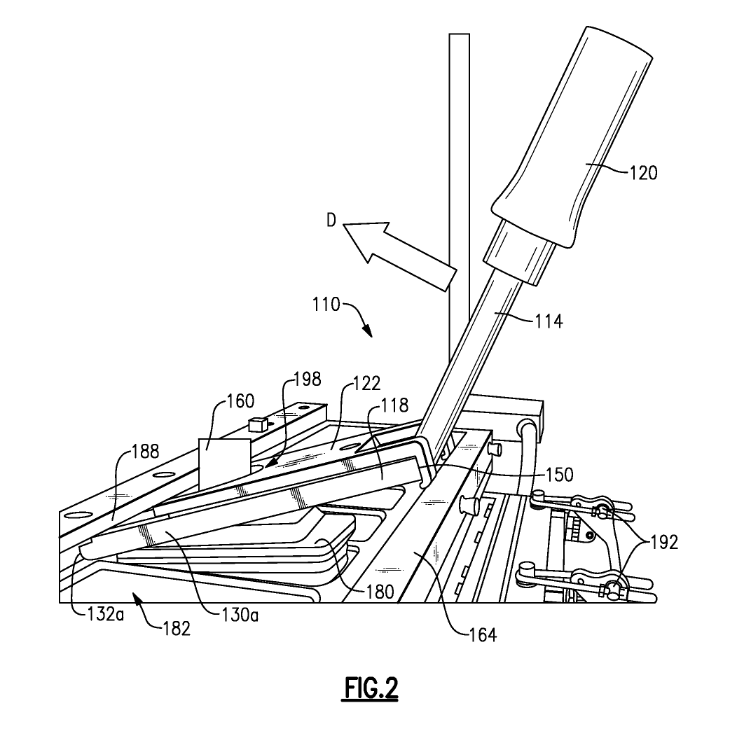

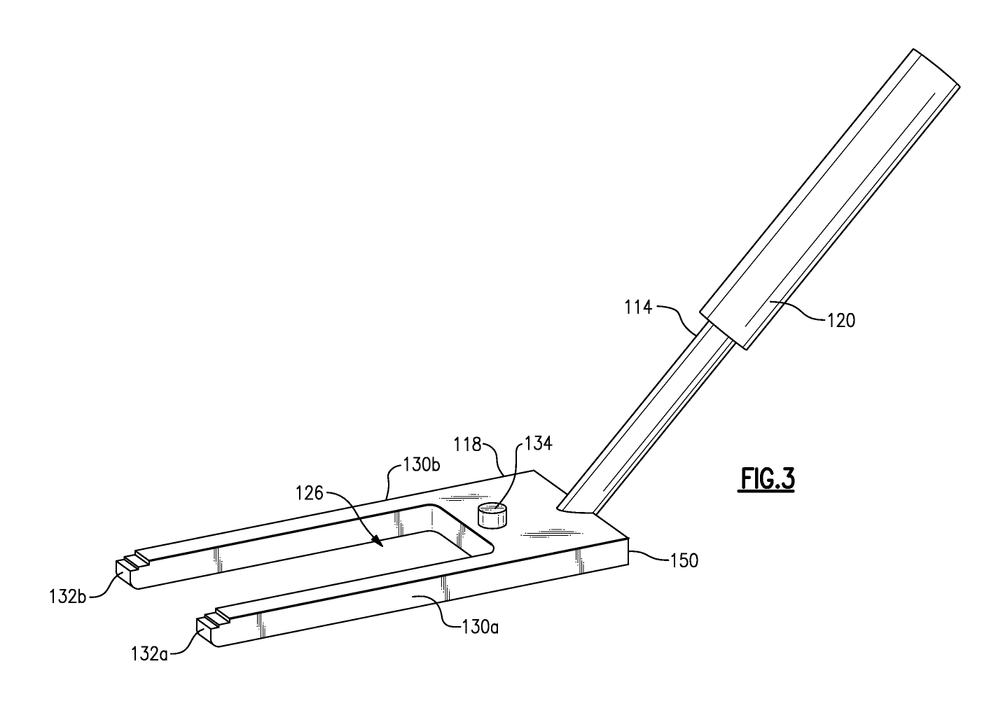

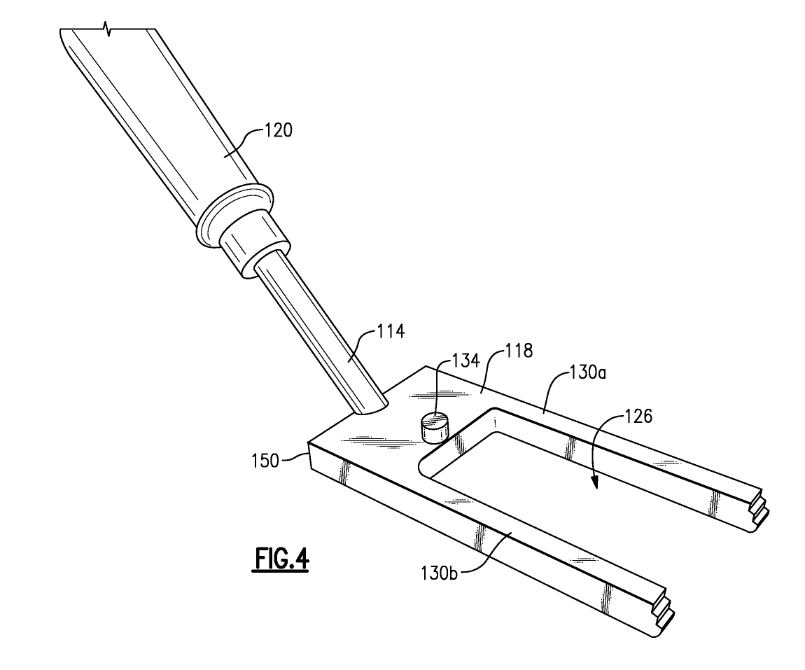

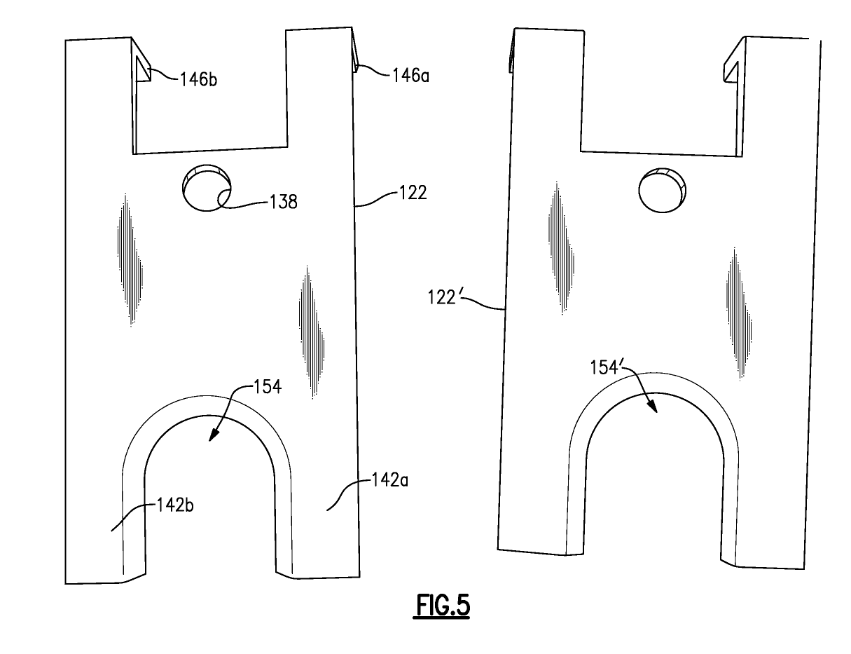

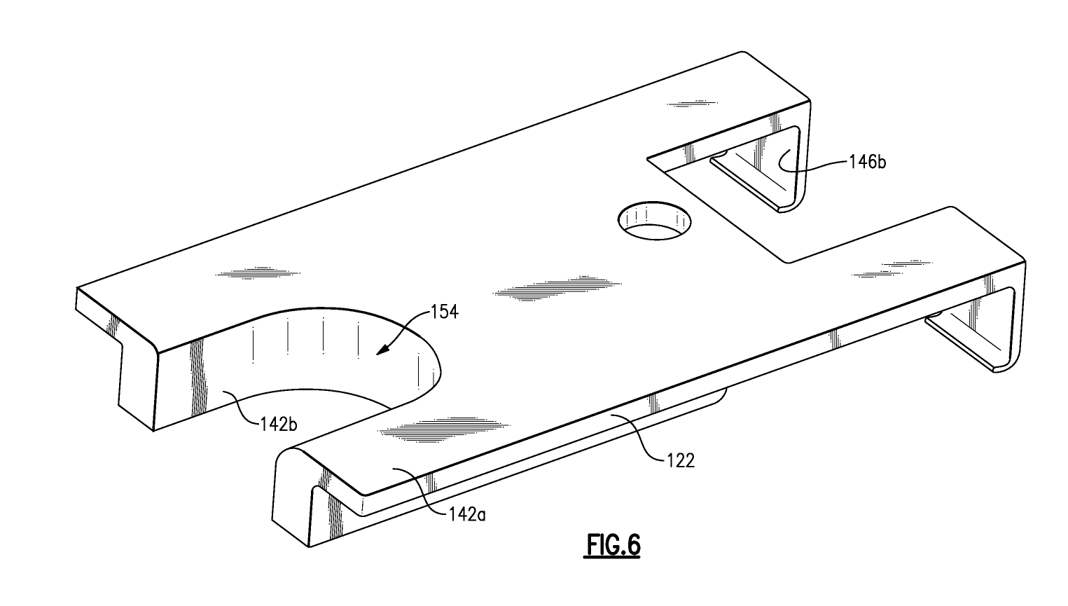

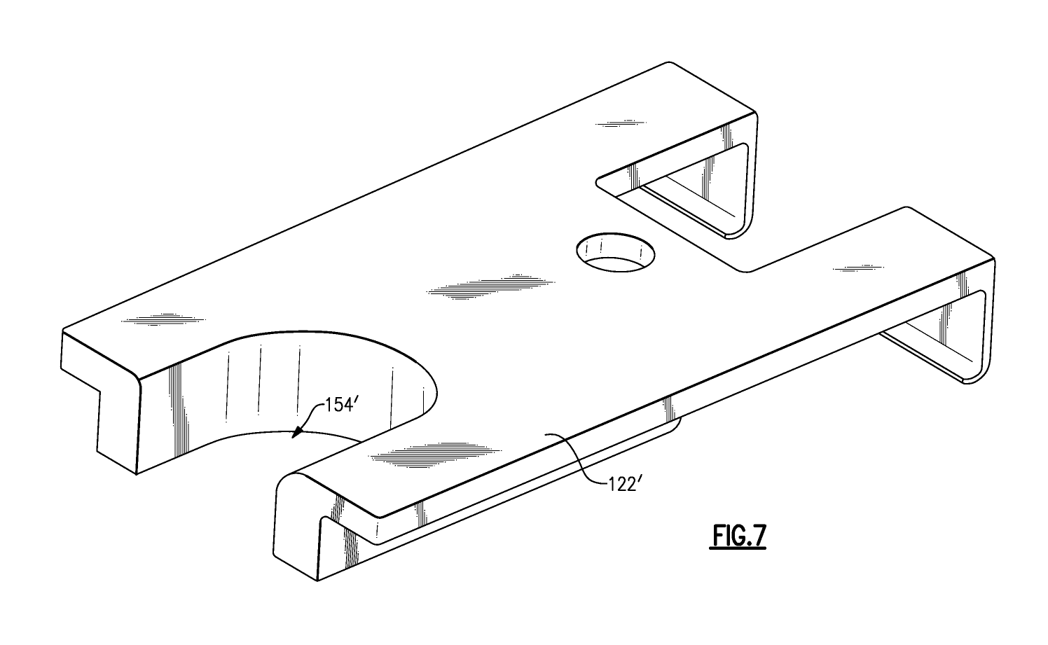

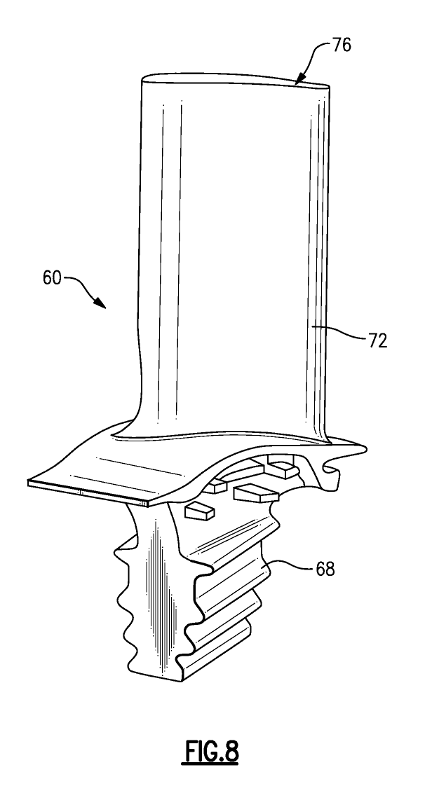

Referring to FIGS. 2 to 8 with continuing reference to FIG. 1, an example extraction tool 110 includes a lever portion 114 connected to a base portion 118. An insert 122 is selectively engageable with the base 118 of the extraction tool 110. The example extraction tool assembly 110 is used to loosen a component 160 from a fixture 164 so that the component 160 may be more easily removed from the fixture 164.

The example component 160 is a blade of the high-pressure compressor 52 of the gas turbine engine 20. The component 160 includes a root 168 and an airfoil 172 extending radially from the root 168 to a tip 176. In this example, the component 160 is held by the fixture 164 when coating the tip 176. The tool 110 is used to loosen the component from the fixture 164 after the coating.

The lever portion 114 of the tool 110 includes a handle 120. The base 118 includes a slot 126 between two arms 130a and 130b that extend away from the lever portion 114 and terminate at tabbed areas 132a and 132b, respectively. The component 160 is positioned within the slot 126 when the tool 110 is loosening the component 106.

The base 118 includes a pin 134 that is received within an aperture 138 established within the insert 122. When the pin 134 is received within the aperture 138, portions of the insert 122 extend within the slot 126 and effectively decrease the size of the slot 126.

The insert 122 includes arms 142a and 142b having hooks 146a and 146b that engage an edge portion 150 of the base 118 to hold the insert 122 in an installed position where the pin 134 is received within the aperture 138.

In other examples, the pin 134 extends from the insert 122, and the base 118 provides the aperture 138. Other examples secure the insert 122 relative to the base 118 using some securing structure other than a pin and an aperture.

The insert 122 includes a slot 154 that accommodates, or receives, a portion of a component 160. Another insert 122′ having a different sized slot 154′ may be used in place of the insert 122 to receive another component having different dimensions from the component 160. That is, by swapping the between the inserts 122 and 122′, the extraction tool assembly 110 can be customized to accommodate the component 160 or a component having another size, such as a blade from another stage of the engine 20.

During the coating, the root 168 is covered by a mask 180, such as a silicone rubber mask. During the coating, the airfoil portion 172, other than the tip 176, is also masked by, for example, a clear coating, such as an acrylic plastic.

The fixture 164 includes several pockets 182. During the coating, the mask 180 and the root 168 are received within one of the pockets 182. The fixture 164, the mask 180, and the component 160 are dipped into a coating fluid during the coating.

To hold the position of the mask 180 and the root 168, a fixture plate (not shown) is placed over the airfoil portion 172. One side of the fixture plate is held in position against the rest of the fixture 164 by a longitudinally extending tab 188. An opposing side of the fixture plate is held in position by clamps 192. The fixture plate limits the movement of the component 160 by preventing the mask 180 and root 168 from moving out of a pocket 182 of the fixture 164.

During the coating process, the coating fluid only contacts the tip 176 of the component 160 due to the masking on the airfoil 172 and the mask 180. The fixture 164 may be moved during the process and various materials may be utilized for the coating. The coating process may cause the component 160 and the mask 180 to become stuck or suctioned within the recessed area 194. Rather than an operator directly pulling the component 160 and the mask 180 from the recessed area 194 after the coating process, the extraction tool assembly 110 is used to first loosen or disengage the component 160 and the mask 180 from the recessed area 194.

In this example, to remove the component 160 and the mask 180, the fixture plate is first removed from the fixture 164. The tabbed areas 132a and 132b of the arms 142a and 142b are then received within the groove under the tab 188, which formerly held the fixture plate. The profiles of the tabbed areas 144a and 144b match the profile of the groove under the tab 188.

An operator then grabs the handle 130 and pivots the extraction tool assembly 110 about the tab 188 in a direction D. After some pivoting, the slot 154 of the insert 122 contacts the airfoil portion 172 of the component 160 at area 198. Continuing to rotate the extraction tool assembly 110 in the direction D after this contact causes the component 160 and the mask 180 to disengage from the recessed area of 194.

The extraction tool assembly 110 enhances the operator's mechanical advantage. The extraction tool assembly 110 effectively loosens the mask 180 from the pockets 182 and overcomes any suction forces holding the mask 180 due to any vacuum introduced by the coating process. Once loosened, the operator is then able to more easily remove the extraction tool assembly 110 and lift the component 160 and the mask 180 from the recessed area 194.

Although the example extraction tool assembly 110 is described with reference to the component 160, which is a turbomachine blade, a person having skill in this art and the benefit of this disclosure may understand other components suitable for extraction by the extraction tool assembly 110.

Features of the disclosed example include a tool that lessens the operator force required to extract a component from a fixture. Another feature of the example extraction tool assembly is improved ergonomics for the operator during the extraction.

The preceding description is exemplary rather than limiting in nature. Variations and modifications to the disclosed examples may become apparent to those skilled in the art that do not necessarily depart from the essence of this disclosure. Thus, the scope of legal protection given to this disclosure can only be determined by studying the following claims.

We claim:

1. An extraction tool assembly comprising:
a base having a slot to receive a component held within a fixture, wherein the base is moved to cause the component to move relative to the fixture.

2. The extraction tool assembly of claim 1, wherein the base is pivoted relative to the fixture to cause the component to move relative to the fixture.

3. The extraction tool assembly of claim 1, wherein the component is a gas turbine engine component.

4. The extraction tool assembly of claim 1, including a first insert and a second insert, the first insert having a first slot configured to engage a first component and the second insert having a second slot that is configured to engage a second component different than the first component, a size of the first slot different than a size of the second slot.

5. The extraction tool assembly of claim 4, wherein the first insert and the second insert are selectively engageable with the base.

6. The extraction tool assembly of claim 4, wherein the first insert and the second insert each include at least one hook to engage an edge portion of the base.

7. The extraction tool assembly of claim 1, including a handle extending from one end of the base.

8. The extraction tool assembly of claim 7, including a pair of arms of the base extending away from a handle end of the base, the slot positioned between the pair of arms.

9. The extraction tool assembly of claim 8, including a tabbed area of the arms to be received within a groove of the fixture.

10. The extraction tool assembly of claim 1, wherein the fixture is a coating fixture.

11. A method of moving a gas turbine engine component relative to a fixture, comprising:
moving an extraction tool relative to a fixture to cause a component held by the fixture to move relative to the fixture.

12. The method of claim 11, including placing the component within a slot of the extraction tool and pivoting the extraction tool to move the component.

13. The method of claim 12, wherein an insert of the tool provides the slot, and the insert is selected based on the component.

14. The method of claim 12, including securing a selected insert to a base portion of the extraction tool to change an effective size of the slot.

15. The method of claim 11, including placing the component within the fixture and coating a portion of the component prior to the moving.

16. The method of claim 15, including coating a tip of the component and masking a remaining portion of the component during the coating.

17. The method of claim 11, including placing a tab of the extraction tool within a groove of the fixture during the moving.

18. The method of claim 11, including contacting a masked area of the component during the moving.
